(19) United States
(12) Patent Application Publication
(10) Pub. No.: US 2007/0288962 A1
(43) Pub. Date: Dec. 13, 2007

(54) GENERATION AND SELECTION OF ENTERTAINMENT PROGRAMMING CHANNELS

(76) Inventors: MICHAEL PIERRE CARLSON, Austin, TX (US); LINDA ARNOLD LISLE, Cedar Park, TX (US); HERMAN RODRIQUEZ, Austin, TX (US)

Correspondence Address: IBM CORP (YA);C/O YEE & ASSOCIATES PC, P.O. BOX 802333, DALLAS, TX, 75380, US

(21) Appl. No.: 11/423,709

(22) Filed: Jun. 13, 2006

(51) Int. Cl. H04N 7/10; H04N 7/025; G06F 13/00; H04N 5/445

(52) U.S. Cl. 725/46; 725/34; 725/35

(57) ABSTRACT

A method, apparatus, and computer program product for generating and displaying programming channel lists. Programming channel lists are generated and displayed according to criteria such as total number of viewers watching the programming channel.

### BACKGROUND

1. Technical Field of the Present Invention

The present invention generally relates to entertainment program channels and, more specifically, to the generation and selection of an entertainment programming channel.

2. Description of Related Art

Today's consumer has an expectation that entertainment will be provided with a variety of options for the selection and control of the entertainment medium. Digital Video Recorders and MP3 players are examples of technological innovations that have arisen as a result of this expectation. In general, these devices assist the ability of the consumer to control the type of content they receive and the time during which it is received.

Although these devices have allowed the consumer to control the type of content and time-shift, they can still miss an important event or fail to watch a particular show, simply, because they were unaware of its popularity until a later point in time. By the time a consumer becomes aware of a particular event or show (e.g., by media such as newspapers, magazines and the like), the particular event is stale or several prior episodes have transpired.

It would, therefore, be a distinct advantage if the consumer could automatically determine the real-time ranking of a broadcast and base their entertainment selection upon this ranking.

### SUMMARY OF THE PRESENT INVENTION

In one aspect, the present invention is a method of generating program information for one or more channels. The method includes the step of broadcasting a plurality of programs on one or more channels. The method also includes the step of ranking each one of the programs according to the number of viewers who have selected the program

In yet another aspect, the present invention is a method of providing programs to a subscriber. The method includes the steps of transmitting a plurality of programs on one or more channels, and ranking each one of the programs according to the number of subscribers selecting the program. The method also includes the step of displaying a list of the programs in the order of their rankings.

### BRIEF DESCRIPTION OF THE DRAWINGS

The present invention will be better understood and its advantages will become more apparent to those skilled in the art by reference to the following drawings, in conjunction with the accompanying specification, in which:

FIG. 1 is a diagram illustrating an example of a broadcasting network having a plurality of viewing stations;

FIG. 2 is a block diagram illustrating a viewing station of FIG. 1 as embodied in a home entertainment system according to a preferred embodiment of the present invention;

FIG. 3 is a diagram illustrating an example for a listing of TV programs;

FIG. 4 is a flow chart is shown illustrating the method of a preferred embodiment of the present invention for gathering, generating and displaying ranked programs;

FIG. 5 is a flow chart illustrating the method of an alternative embodiment of the present invention for ranking, displaying, and tuning to selected programs;

FIG. 6 is a diagram illustrating an example of a ranked listing according to the teachings of the preferred embodiment of the present invention;

FIG. 7 is a diagram illustrating an example of a ranked listing created using an additional filter according to the teachings of a preferred embodiment of the present invention; and

FIG. 8 is a diagram illustrating an example of a ranked listing created using an additional filter according to the teachings of a preferred embodiment of the present invention.

### DETAILED DESCRIPTION OF THE PREFERRED EMBODIMENT OF THE PRESENT INVENTION

The present invention is a method, apparatus, and computer program product for selecting a programming channel based upon its popularity or ranking. More specifically, the present invention allows a user to tune into a programming channel based upon numerous factors that will result in a listing of the receivable programs in the order of relevance to certain factors (e.g., popularity).

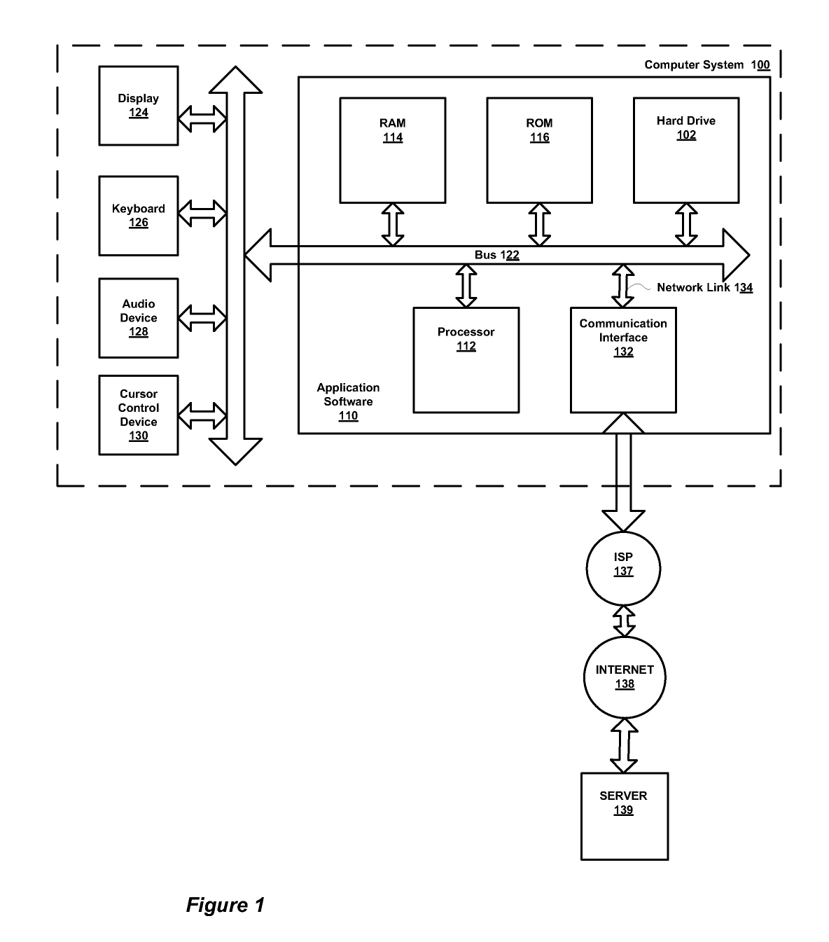

Reference now being made to FIG. 1, a diagram is shown illustrating an example of a broadcasting network 100. The broadcasting network 100 includes a broadcasting facility 120 coupled to one or more viewing stations 140-140N via a communication medium 160.

The communication medium 160 can be any medium (e.g., fiber optic cable) that is suitable for delivering signals over long distances between the broadcasting facility 120 and the viewing stations 140-140N. The communication medium 160 can be wired or wireless (e.g., satellite reception) or any combination thereof (e.g., satellite with a phone line or DSL connection). In a preferred embodiment of the present invention, the communication medium 160 supports bi-directional communication between each of the viewing stations 140-N and the broadcasting facility 120.

The broadcasting network 100 telecasts a plurality of video and audio programs simultaneously over a plurality of programming channels on the communication medium 160. All of the viewing stations 140-N have access to these programs. A viewer can view a particular broadcast by tuning one of the viewing stations 140-N to the programming channel that is carrying the program of interest.

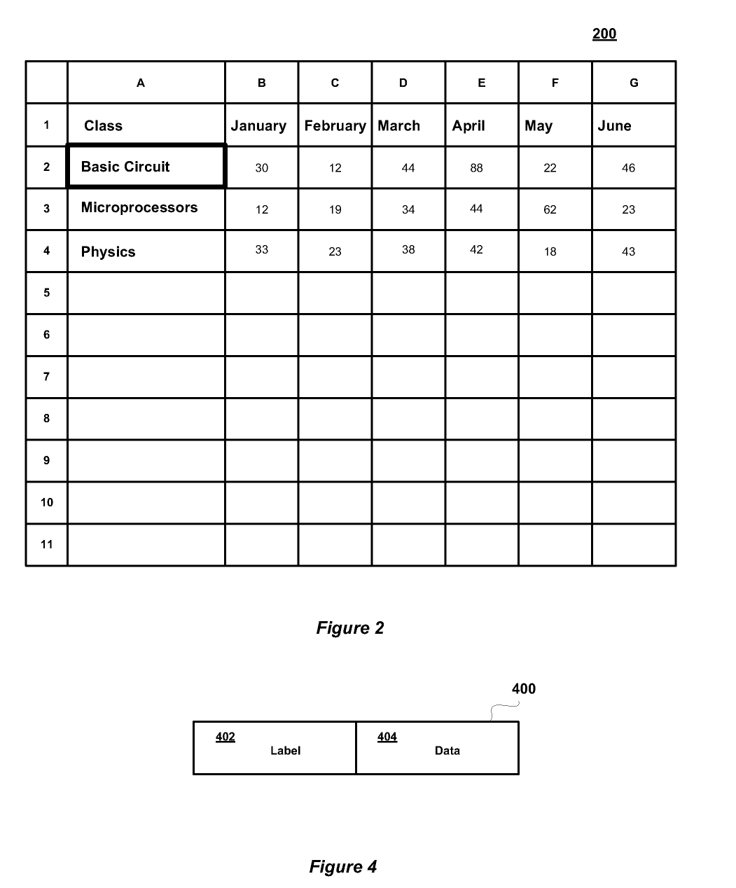

The viewing stations 140-N are typically located in the homes of viewers or other locations that are capable of receiving the content programming. Each of the viewing stations 140-N preferably includes a conventional television monitor or other suitable viewing device. For example, a viewing station 140-N can be an entertainment system such as that illustrated in FIG. 2 below.

Reference now being made to FIG. 2, a block diagram is shown illustrating the viewing station 104 as embodied in a home entertainment system 104 according to a preferred embodiment of the present invention. The home entertainment system 104 includes a communication unit 104a (e.g. set-top), a viewing device 104b, and a remote control 104c.

The communication unit 104a is coupled to or communicates with the broadcasting facility 120 using medium 160 which can be wired to the broadcasting facility 120 or alternatively receive wireless signals from a satellite or other wireless communication device or any combination thereof (e.g., wireless and wired).

Viewing device 104b can be any device capable of providing visual and/or audio information to a viewer. For example, viewing device 104b can be a TV, computer monitor, cell phone, radio, MP3 player and the like.

Depending upon the type of viewing device 104b, remote control 104c can be part of the viewing device 104b itself or, as illustrated, a separate device. The function and operation of remote control 104c with viewing device 104b is implemented using well-known and understood techniques.

Information displayed on the viewing device 104b is typically shown in a list type format according to channel numbers or the like. In a preferred embodiment of the present invention, the broadcasting channels are ranked according to popularity and listed accordingly. Alternatively, the viewer can indicate additional criteria to further limit the size of the list or ranking according to selective criteria as explained below.

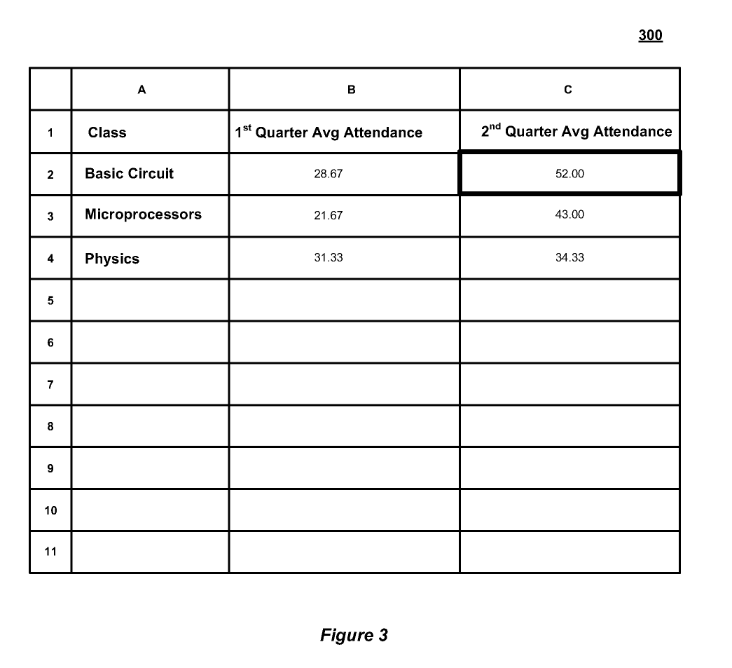

Reference now being made to FIG. 3, a diagram is shown illustrating an example for a listing 300 of TV programs. In this instance, the channels are organized in descending order according to their respective numbers (e.g., 147 to 23). Program information for each channel is provided according to specified time periods such as 30-minute increments (e.g., SportsZone starts at 8:00 p.m. and ends at 9:00 p.m.). Obviously, there are numerous ways in which the program information can be displayed using other criteria such as themes and the like.

Reference now being made to FIG. 4, a flow chart is shown illustrating the method of a preferred embodiment of the present invention for gathering, generating and displaying ranked programs. The method begins when the broadcasting facility 120 (FIG. 1) gathers information concerning the popularity of the programs it offers to its subscribers to determine ranking (Steps 400-402).

The gathering of this information can be accomplished by the broadcasting facility 120 polling the viewing stations 104-N via the communication unit 104a (FIG. 2) or other means (e.g., phone line connected to the communication unit 104a or other sources such as another company that gathers this information) during predetermined intervals and rank the programs according to the gathered information (step 404). The ranking can be based upon actual real-time numbers or statistical based analysis.

In a preferred embodiment of the present invention, the broadcasting facility 120 dedicates one or more channels to view the ranked programs (Step 406). The programs provided on these dedicated channels are updated according to their ranking during a predetermined time period (e.g., every 15 minutes) (step 408). In this preferred embodiment, the user has the ability to tune into the ranked program(s) by selecting the dedicated channel(s) (e.g., top 10 shows and/or bottom 10 shows) (step 412).

In an alternative embodiment of the present invention, the user is provided with the ability to indicate their desire to view either the most or least popular program via a remote control or other indicating means. Upon the selection of the desired ranked program, the viewing device 104b is tuned to the selected program (steps 410 and 412).

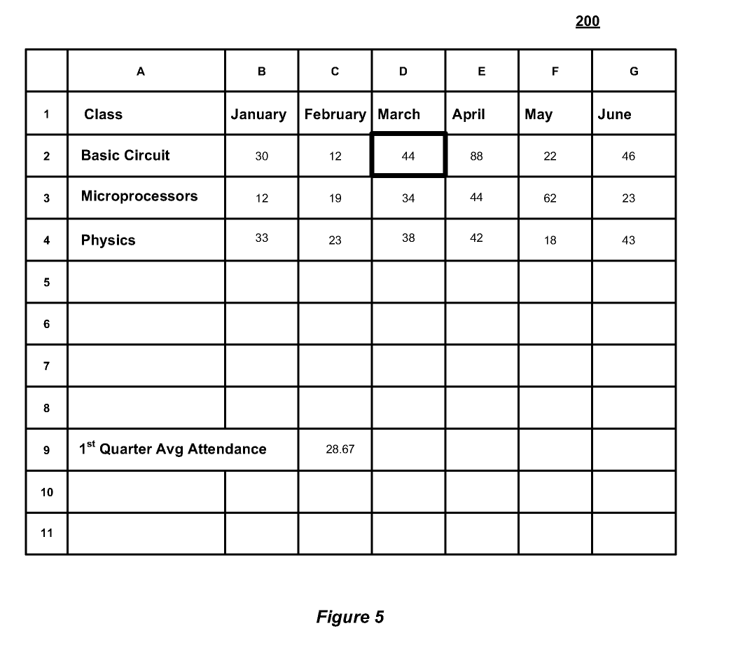

Reference now being made to FIG. 5, a flow chart is shown illustrating the method of an alternative embodiment of the present invention for ranking, displaying, and tuning to selected programs. The method begins by gathering the information and ranking the programs as previously described in connection with FIG. 4 (steps 500-504). In this alternative embodiment, the broadcasting facility 120 (FIG. 1) offers the viewer several options for organizing and generating additional lists for the rankings of the programs.

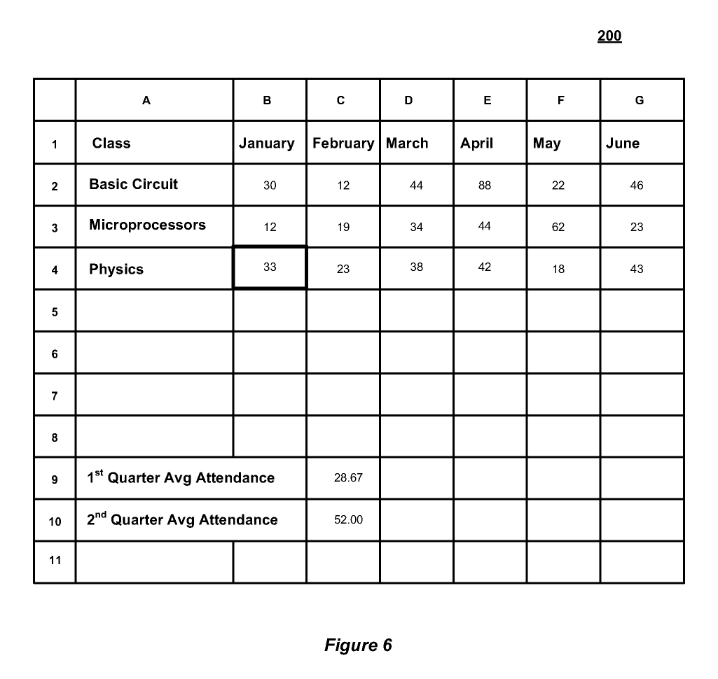

For example, as illustrated in FIG. 6, a diagram is shown illustrating an example of ranked listing 600 according to the teachings of the preferred embodiment of the present invention. The listing 600 is shown in a format that is similar to that used for the presentation of listing 300 in FIG. 3. In this example, however, the programs have been sorted in ascending order according to their past (for time periods that have already elapsed), present (for the current time period), and future (based upon prior rankings during a predefined time period or anticipated ranking). More specifically, at the 7:00 p.m. time slot the programs are ranked as follows: 1) American Idol™; 2) Friends™; 3) Larry King Live™; 4) Invasion™; 5) Monday Night Football™.

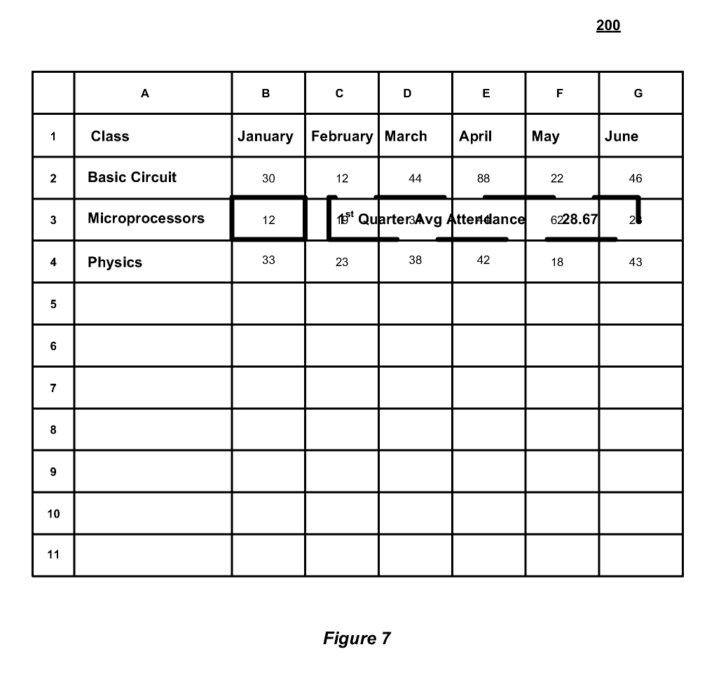

The user is provided with the ability to generate additional lists of the rankings based upon other factors such as theme, demographics, location, gender, popularity of commercial, and the like. For example, the ranked listing 600 of FIG. 6 can be further filtered or ranked according to gender as illustrated in FIG. 7. In this instance, male viewers were chosen as an additional filter and the programs have been ranked as follows: 1) Monday Night Football™; 2) Invasion™; 3) Battlestar Galactica™; and 4) Sports Illustrated™.

In contrast, when the chosen gender is female, the ranked listing 600 of FIG. 6 is altered as shown in the ranked listing 800 of FIG. 8. In this selection, the programs have been ranked as follows: 1) American Idol™; 2) Friends™; 3) Larry King Live™; and 4) Desperate Housewives™.

The complete listing of the rankings and their filter alternatives are preferably stored at each of the viewing stations 104-N (Step 506). Alternatively, the non-filtered rankings can be stored at the viewing stations 104-N and the filtered versions provided upon request from the broadcasting facility 120 or any combination thereof. Upon the selection of a channel from the ranked listing, the viewing device 104b is tuned to the selected channel (Steps 508-510).

The present invention, including the alternative preferred embodiments, can be provided as a computer program product, included on a machine-readable medium having stored on it machine executable instructions used to program computer system to perform a process according to the teachings of the present invention.

The term “machine-readable medium” as used in the specification includes any medium that participates in providing instructions to a processor or other components of a computer system for execution. Such a medium can take many forms including, but not limited to, non-volatile media, and transmission media. Common forms of non-volatile media include, for example, a floppy disk, a flexible disk, a hard disk, magnetic tape, or any other magnetic medium, a Compact Disk ROM (CD-ROM), a Digital Video Disk-ROM (DVD-ROM) or any other optical medium whether static or rewriteable (e.g., CDRW and DVD RW), punch cards or any other physical medium with patterns of holes, a programmable ROM (PROM), an erasable PROM (EPROM), electrically EPROM (EEPROM), a flash memory, any other memory chip or cartridge, or any other medium from which a computer system can read and which is suitable for storing instructions.

It is thus believed that the operation and construction of the present invention will be apparent from the foregoing description. While the method and system shown and described has been characterized as being preferred, it will be readily apparent that various changes and/or modifications could be made without departing from the spirit and scope of the present invention as defined in the following claims.

What is claimed is:

1. A method of generating program information for one or more channels, the method comprising:
broadcasting a plurality of programs on one or more channels; and
ranking each one of the programs according to the number of viewers who have selected the program.

2. The method of claim 1 further comprising:
dedicating at least one channel to display one or more of the ranked programs.

3. The method of claim 1 wherein the step of ranking includes:
receiving program information to determine the program the viewers have selected.

4. The method of claim 3 wherein the step of receiving program information includes:
receiving program information from one or more subscribers that belong to the same programming network to determine what program the viewers have selected.

5. The method of claim 4 wherein each one of the subscribers has a set-top device, and the step of polling includes:
transmitting program information from the set-top device to determine the program that the subscribers have selected.

6. The method of claim 4 wherein the step of dedicating at least one channel includes:
dedicating at least one channel to display the program selected by the greatest number of viewers.

7. The method of claim 6 wherein the step of ranking includes:
ranking the programs according to a statistical analysis of a sampling of polled subscribers.

8. The method of claim 5 wherein at least one of the programming channels is a video channel.

9. A method of providing programs to a subscriber, the method comprising:
transmitting a plurality of programs on one or more channels;
ranking each one of the programs according to the number of subscribers selecting the program; and
displaying a list of the programs according to their rankings.

10. The method of claim 9 further comprising:
selecting one of the listed programs; and
changing the selection of a current channel carrying a different one of the programs to a channel carrying the selected program.

11. The method of claim 10 wherein the number of subscribers is equal to the total number of subscribers to a network.

12. The method of claim 10 wherein the number of subscribers is a sampling of the total number of subscribers.

13. The method of claim 11 wherein the number of subscribers is a defined group of the total number of subscribers.

14. The method of claim 11 wherein the number of subscribers is a statistical representation of a defined group of the total number of subscribers.

15. The method of claim 12 wherein the subscribers belong to the same network.

16. The method of claim 12 wherein a portion of the subscribers belong to at least one different network from the other portion of subscribers.

17. A computer program product comprising a computer usable medium having computer usable program code for providing programs to a subscriber, the computer usable program code comprising:
computer usable program code for broadcasting a plurality of programs on one or more channels;
computer usable program code for ranking each one of the programs according to the number of subscribers selecting the program; and
computer usable program code for displaying a list of the programs according to their rankings.

18. The computer program product of claim 17 further comprising:
computer usable program code for selecting one of the listed programs; and
computer usable program code for changing the selection of a current channel carrying a different one of the programs to a channel carrying the selected program.

19. The computer program product of claim 18 wherein the number of subscribers is equal to the total number of subscribers to a network.

20. The computer program product of claim 18 wherein the number of subscribers is a sampling of the total number of subscribers.
